(19) United States
(12) Patent Application Publication
(10) Pub. No.: US 2015/0043830 A1
(43) Pub. Date: Feb. 12, 2015

(54) METHOD FOR PRESENTING PICTURES ON SCREEN

(71) Applicant: Yang XU, Irvine, CA (US)

(72) Inventor: Yang XU, Irvine, CA (US)

(21) Appl. No.: 13/962,683

(22) Filed: Aug. 8, 2013

(51) Int. Cl. G06K 9/62

(52) U.S. Cl. CPC G06K 9/6202
USPC 382/218

(57) ABSTRACT

This invention discloses methods and systems to present objects on a screen. Objects are presented within a display area of the screen. In an embodiment, a first weighting factor comprising a size R(s), a width-to-height ratio R(r), a focus R(f), a face or eye position R(c), and a position coordinate R(p) parameters is calculated for each object. The objects are rearranged by comparing the first weighting factor of the objects.

### BACKGROUND OF THE INVENTION

1. Field of the Invention

The present invention relates to systems and methods for presenting pictures on screen of mobile devices.

2. Description of Related Art

A graphical user interface (GUI) is a type of user interface that allows users to interact with electronic devices using images rather than text commands. GUIs can be used in, for example, tablet computers, hand-held devices such as cell phones and MP3 players, portable media players or gaming devices, and the like. Generally a GUI device, e.g., a one-piece mobile tablet computer, has a touchscreen with finger or stylus gestures replacing the conventional computer mouse.

A GUI represents the information and actions available to a user through graphical icons and visual indicators, as opposed to text-based interfaces, typed command labels, or text navigation. The actions are usually performed through direct manipulation of the graphical elements

In some application a photo book including a plurality of pictures are displayed in a two-dimensional graphic user interface (GUI), such as a window with a limited display area. The application may be enable the user to select and print each of the pictures. The displayed pictures contain different information with one another, and usually an important picture may be disposed in a position easily to be ignored.

### SUMMARY OF THE INVENTION

In one general aspect, the present invention relates to methods and systems presenting objects on a screen, and rearranging the objects according to the information and/or features contained therein.

An embodiment of this invention discloses a computer-implemented method for presenting objects on a screen of a device, which comprises the steps of: presenting a plurality of objects within a display area of the screen; calculating a first weighting factor for each of the plurality of objects, wherein the first weighting factor comprises a size R(s), a width-to-height ratio R(r), a focus R(f), a face or eye position R(e), and a position coordinate R(p) parameter; and rearranging the plurality of objects by comparing the first weighting factor of the plurality of objects.

Another embodiment of this invention discloses a computer-implemented method for presenting objects on a screen of a device, which comprises the steps of: presenting a plurality of objects within a display area of the screen; calculating a second weighting factor for each of the plurality of objects, wherein each of the plurality of objects is divided into nine blocks, and an entropy E(beₙ) is calculated for each block by the following equation:

E(beₙ)=−sum(g·log₂(g)),

wherein n=1−9 and g denotes the grayscale of individual pixel within the block under calculation, and the second weighting factor W2 of each object is calculated by the equation

W2=E(be₁)+E(be₂)+E(be₃)+E(be₄)+E(be₅)+E(be₆)+E(be₇)+E(be₈)+E(be₉);

and
rearranging the plurality of objects by comparing the second weighting factor of the plurality of objects.

Another embodiment of this invention discloses a computer-implemented method for presenting objects on a screen of a device, comprising the steps of: presenting a plurality of objects within a display area of the screen; calculating a first weighting factor for each of the plurality of objects; calculating a second weighting factor for each of the plurality of objects; and rearranging the plurality of objects by comparing the first weighting factor and/or the second weighting factor of the plurality of objects.

### BRIEF DESCRIPTION OF THE DRAWINGS

FIG. 1 shows a method for presenting objects on a screen according to an embodiment of this invention.

FIG. 2 shows a method for presenting objects on a screen according to another embodiment of this invention.

FIG. 3 shows each object of the display area is divided into nine blocks according to the embodiment recited in FIG. 2.

FIG. 4 shows a method for presenting objects on a screen according to another embodiment of this invention

FIG. 5 shows an example in which five objects within a display area are rearranged by the method of this invention.

FIG. 6 shows another example in which five objects within a display area are rearranged by the method of this invention.

### DETAILED DESCRIPTION OF THE PREFERRED EMBODIMENT

Reference will now be made in detail to those specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known process operations and components are not described in detail in order not to unnecessarily obscure the present invention. While drawings are illustrated in detail, it is appreciated that the quantity of the disclosed components may be greater or less than that disclosed, except where expressly restricting the amount of the components. Wherever possible, the same or similar reference numbers are used in drawings and the description to refer to the same or like parts.

This invention relates method and system for presenting objects, e.g., two-dimensional or three-dimensional pictures or photos, in a display area of a screen of a device, preferably a mobile device, such as a smart phone or a tablet computer.

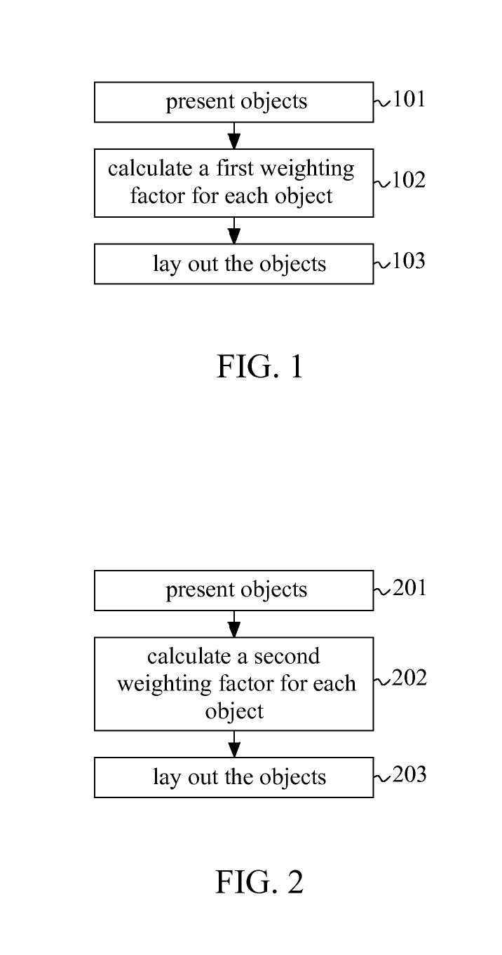

FIG. 1 is a flow chart showing one exemplary embodiment of a method for presenting objects on a screen of a mobile device. The method may comprise the following steps.

In step 101, a plurality of objects is presented on a display area of the screen of the device. In one embodiment of this invention, the plurality of objects are firstly received by a receive module and then displayed by a presenting module of the mobile device. In another embodiment of this invention, the presenting module of the mobile device displays the objects from a storage unit, which may be a magnetic or optical storage device and originally installed within or inserted into the device.

Preferably, an “object” may refer to, but is not limited to, a two-dimensional or three-dimensional picture. In addition, the term “module” used herein may refer to logic embodied in hardware or firmware, or refer to a collection of software instructions written in a programming language. The modules described herein may be implemented as either software and/or hardware modules and may be stored in any type of non-transitory computer-readable medium or other storage device.

In step 102, a first weighting factor is calculated for each object displayed in the display area of the screen.

In a preferred embodiment of this invention, the first weighting factor comprises five parameters: size R(s), width-to-height ratio R(r), focus R(f), face or eye position R(e), and position coordinate R(p).

The size R(s) denotes the resolution or the number of pixel of the object under calculation. For example, a specific number R(s) is determined by the resolution or the number of pixel of the object under calculation. The word “pixel” used herein may refer to the smallest single component of a digital image, or may refer to “printed pixels” in a page, pixels carried by electronic signals, pixels represented by digital values, pixels on a display device, or pixels in a photosensor element. In a preferred embodiment of this invention, the term “pixels” is used as a measure of resolution.

For example, specific integers R(s) 1, 2, 3, 4, and 100 are respectively determined if the resolution or the number of pixel of the object under calculation is 0-3 megapixels, 3-6 megapixels, 6-9 megapixels, 9-12 megapixels, and 12-15 megapixels, respectively. If m and n are integers, the term “m-n megapixels” may refer to the resolution or the number of pixel of the object under calculation are more than m megapixels and less than or equal to n megapixels, or more than or equal to m megapixels and less than n megapixels.

For example, the parameter R(r) is determined by the width-to-height ratio of the object under calculation. According to the width-to-height ratio, a number R(s), e.g., an integer between 1 and 100, is determined.

For example, the parameter R(f) is determined by the focus of the object under calculation. In particular, the parameter R(f) is determined by the equation f(x, y)/(w, h), where f(x, y) denotes the coordinate of the focus of the object, under calculation, and (w, h) is the coordinate defined by the width (w) and height (h) of the object under calculation. The origin of the coordinates is the upper left corner of the object under calculation. By this definition, the coordination (w, h) is the coordinate of the lower right corner of the object under calculation.

The focus f(x, y) is determined by the following method. A histogram is plotted to show the distribution of the grayscale difference between each pixel and its next pixel of the object under calculation. A peak can be found from the histogram. The peak corresponds to a coordinate of a pixel, and then it is verified that if all the grayscale differences between this pixel and its neighbor pixels are falling within a predetermined range, then consider this pixel as the focus of the object, and the coordinate of this pixel will be the focus as f(x, y). If the above-mentioned method fails to find the focus, then use the coordinate of the center of the object under calculation as the focus f(x, y).

For example, the parameter R(e) is determined by the coordinates of the face or eyes presented in the object under calculation. In particular, the parameter R(e) is determined by the equation: e(x, y)/(w, h), where the e(x, y) is the coordinate or the face or eyes presented in the object under calculation, and (w, h) is the coordinate defined by the width and height of the object under calculation. The origin of the coordinates is the upper left corner of the object under calculation. According to the ratio e(x, y)/(w, h), a number R(e), e.g., an integer between 1 and 100, is determined.

For example, the position coordinate parameter R(p) is determined by the coordinate of the upper left corner of the object under calculation. In particular, the parameter R(p) is determined by the equation: p(x, y)/(w, h), where the p(x, y) is the coordinate of the upper left corner of the object under calculation, and (w, h) is the coordinate defined by the width and height of the object under calculation. In this step, the origin of the coordinates is the upper left corner of the display area. According to the ratio p(x, y)/(w, h), a number R(p), e.g., an integer between 100 and 1, is determined.

Accordingly, the first weighting factor W1 of each object can be calculated by the following equation:

W1=R(s)+R(r)+R(f)+R(e)+R(p),

where R(s), R(r), R(f), R(e), and R(p) respectively denote the mentioned five parameters: size R(s), width-to-height ratio R(r), focus R(f), face or eye position R(e), and position coordinate R(p).

In step 103, the layout of the objects is rearranged (re-laid out) by comparing the first weighting factors of the objects. Each object in the display area can be re-sized, moved, cut down, magnified, diminished, shrunk, compacted, and/or extended by comparing all the first weighting factors of the displaying objects, and the rearrangement may has one or more of the above-mentioned treatments for each object.

Preferably, the rearrangement may follow one or more rules. For example, if all the objects presented in a display area have the same size R(s) and width-to-height ratio R(r), then the object with their focus R(f) and eye position R(e) being nearer to its center than others, may be rearranged at the left and the front (with priority order to be view by the user) of the display area. For example, the object with largest size R(s) may be rearranged in the primary position of the display area, the object with the second largest size R(s) may be rearranged in the secondary position of the display area, and so on. For example, the object with width-to-height ratio R(r) nearest to 4:3 may be rearranged and/or treated to be most conspicuous and placed in the primary position of the display area. For example, the upper left corner of the display area may be defined as the primary position, and its right position may be defined as the secondary position, and so on.

In addition, a user may manipulate the rearrangement. The user may tap one or more objects and drag them to the wanted positions of the display area, in which the object dragged to the left of the display area may be considered to be most important and then rearranged and/or treated to be most conspicuous. In an example, when the user taps one object and drags it to any position of the display area, the other objects of the display area are simultaneously rearranged according to steps 101-103.

FIG. 2 is a flow chart showing another preferred embodiment of a method for presenting objects on a screen of a mobile device. The method may comprise steps 201 and 203 corresponding to the steps 101 and 103 as discussed in FIG. 1, while differs from FIG. 1 in that a second weighting factor is used to replace the first second weighting factor.

In step 202, a second weighting factor is calculated for each object displayed in the display area of the device.

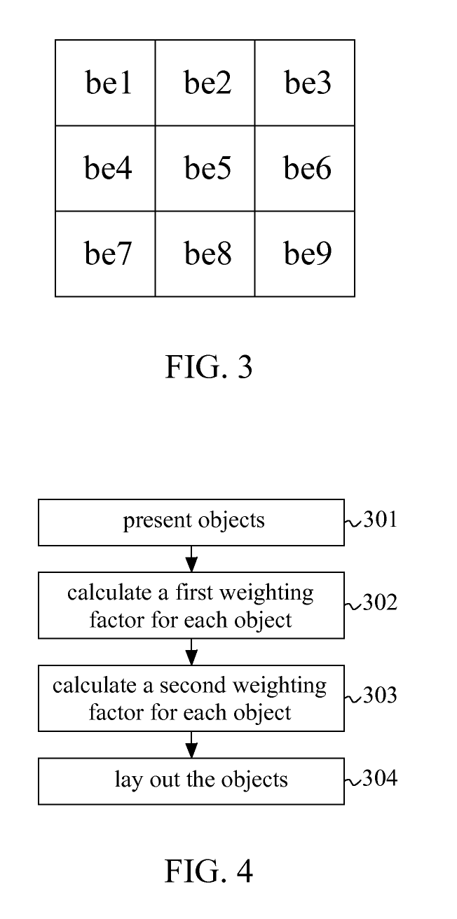

In step 202, each object of the display area is divided into nine blocks namely be1, be2, be3, be4, be5, be6, be7, be8, and be9 as shown in FIG. 3, and an entropy is calculated for each block. The entropy can be used to estimate the readability of the objects from the view of color and texture of the considered object. For example, the entropy of each block can be calculated by the following equation:

E(beₙ)=−sum(g·log₂(g)),

where n denotes the serial number of the blocks within the object under calculation (e.g., n=1−9) and g denotes the grayscale of individual pixel within the block.

And then the second weighting factor W2 of each object can be calculated by the following equation:

W2=E(be₁)+E(be₂)+E(be₃)+E(be₄)+E(be₅)+E(be₆)+E(be₇)+E(be₈)+E(be₉),

where E1 (be₁) denotes the entropy of the upper left block of the object under calculation, E2 (be₂) denotes the entropy of the upper middle block of the object under calculation, and so forth.

In step 203, the objects within the display area are laid out (rearrangement) according to the second weighting factor W2. For example, the object with the largest second weighting factor may indicate that it has more information than others, so that this object may be rearranged and/or treated to be, e.g., magnified. For example, the object(s) with small second weighting factor may be selected to be shrunk or scaled down. If one object needed to be cut down a portion, three connected blocks of the object, with a smaller block second weighting factor, may be selected to be cut down. For example, if the connected be₁-be₂-be₃ block of one object has smaller summed block second weighting factor than that of the connected be₄-be₅-be₆ block and be₇-be₈-be₉ block, then the connected be₁-be₂-be₃ block may be selected to be cut down.

Similarly, a user may manipulate the rearrangement. The user may tap one or more objects and drag them to the wanted positions of the display area, in which the object dragged to the left of the display area may be considered to be most important and then rearranged and/or treated to be most conspicuous. In an example, when the user taps one object and drags it to any position of the display area, the other objects of the display area are simultaneously rearranged according to steps 201-203.

FIG. 4 is a flow chart showing another preferred embodiment of a method for presenting objects on a screen of a mobile device. The method may comprise steps 301, 302 corresponding to the steps 101 and 102 as discussed in FIG. 1, and comprises step 303 corresponding to the step 202 as discussed in FIG. 2, and further features in a step 304, in which the objects within the display area are laid out (rearrangement) according to the first weighting factor W1 and the second weighting factor W2.

Similarly, a user may manipulate the rearrangement. The user may tap one or more objects and drag them to the wanted positions of the display area, in which the object dragged to the left of the display area may be considered to be most important and then rearranged and/or treated to be most conspicuous. In an example, when the user taps one object and drags it to any position of the display area, the other objects of the display area are simultaneously rearranged according to steps 301-304.

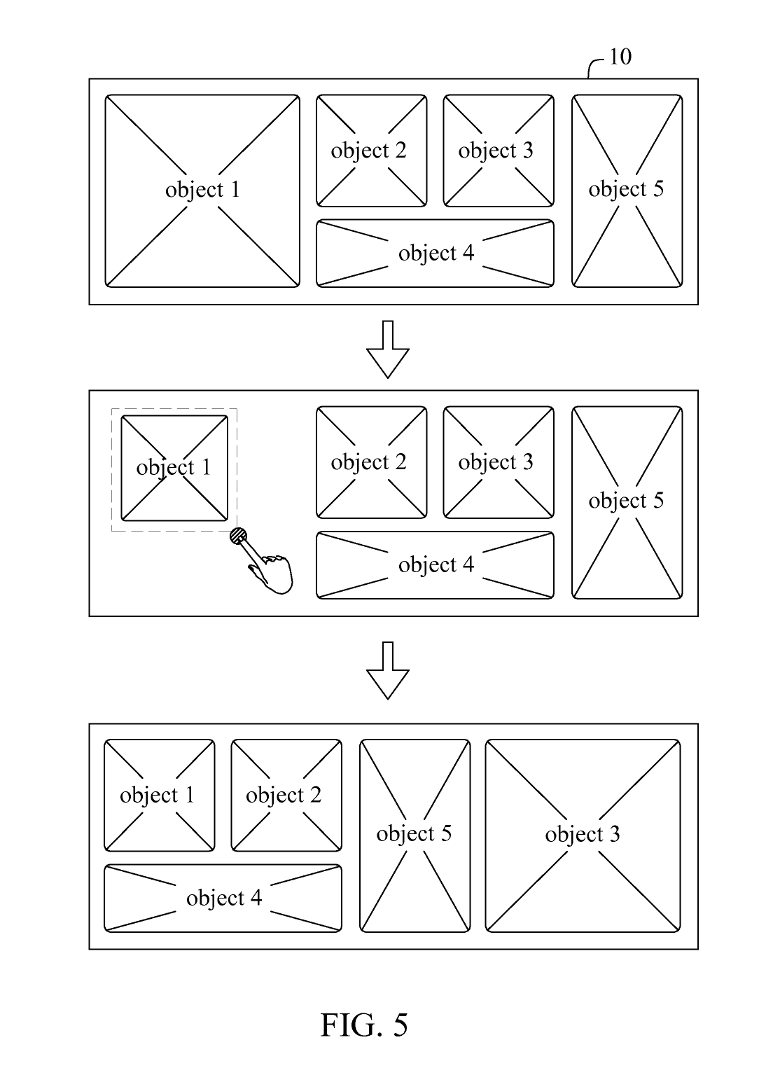

FIG. 5 shows an example in which five objects within a display area 10 are rearranged by the method of this invention as discussed in FIGS. 1, 2, or 4. In this example, a user is tapping object 1 and scaling down object 1, and the method of this invention is simultaneously rearranging the other objects within the display area.

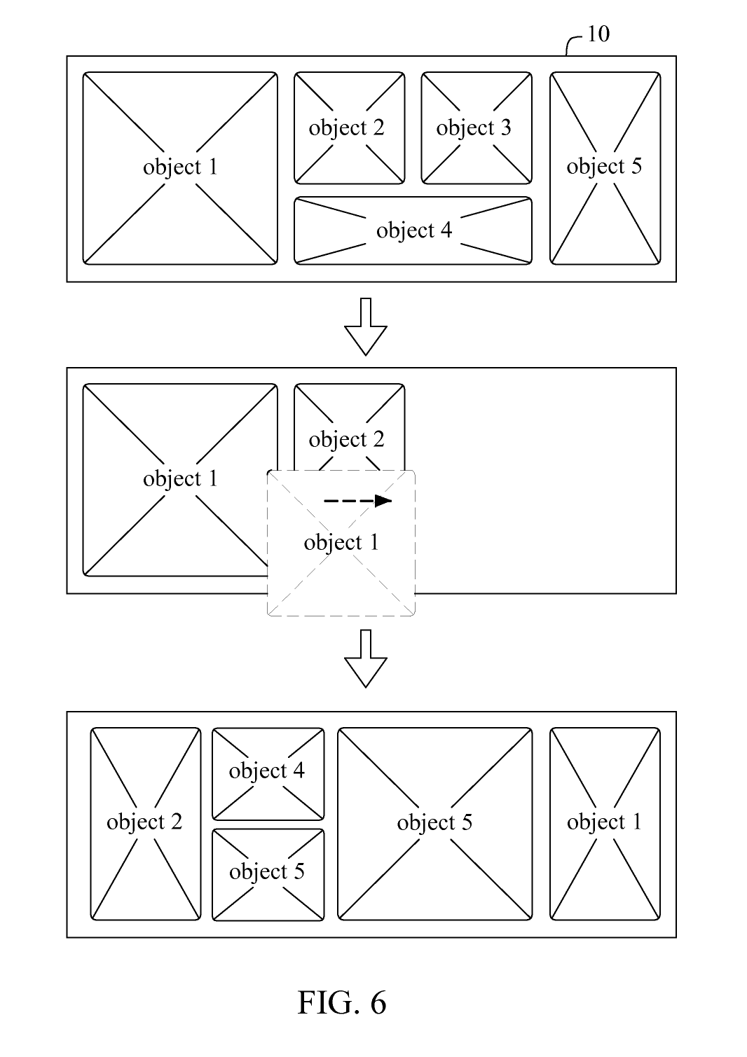

FIG. 6 shows another example in which five objects within a display area 10 are rearranged by the method of this invention as discussed in FIGS. 1, 2, or 4. In this example, a user is tapping object 1 and moving it to the right of the display area 10, and the method of this invention is simultaneously rearranging the other objects within the display area.

In addition, in a preferred embodiment one or more methods of this invention further comprise a step of defecting whether an object within the display area is moved or resized by the user. And if the object is moved, then rearrange the other objects within the display area by the steps recited in FIG. 1, or if the object is resized, then rearrange the other objects within the display area by the steps recited in FIG. 2.

Modifications may be made for the method of this invention. For example, if the method is applied to a photo book or photo album including a plurality of pages, the rearrangement of the method may be limited to the current displaying page, or, may be applied to the current displaying page and one or more other pagers, or applied to all the pages.

One or more above-described methods may be executed through a mobile application, which is a software application designed to run on smartphones, tablet computers, and other mobile devices. The mobile application may be usually available through application distribution platforms, which are typically operated by the owner of the mobile operating system, such as the Apple App Store, Google Play, Windows Phone Store, and BlackBerry App World. The mobile application can be downloaded from the platform to the user's mobile device, but it can also be downloaded to laptops or desktops.

Although specific embodiments have been illustrated and described, it will be appreciated by those skilled in the art that various modifications may be made without departing from the scope of the present invention, which is intended to be limited solely by the appended claims.

What is claimed is:

1. A computer-implemented method for presenting objects on a screen of a device, comprising the steps of:
presenting a plurality of objects within a display area of the screen;
calculating a first weighting factor for each of the plurality of objects, wherein the first weighting factor comprises a size R(s), a width-to-height ratio R(r), a focus R(f), a face or eye position R(e), and a position coordinate R(p) parameter; and
rearranging the plurality of objects by comparing the first weighting factor of the plurality of objects.

2. The method as recited in claim 1, further comprising a step to calculate a second weighting factor for each of the plurality of objects, and the rearrangement of the plurality of objects is made by comparing the first weighting factor and/or the second weighting factor of the plurality of objects.

3. The method as recited in claim 2, wherein each of the plurality of objects is divided into nine blocks, and an entropy En is calculated for each block by the following equation:
E(beₙ)=−sum(g·log₂(g)),
wherein denotes the serial number of blocks (n=1−9) and g denotes the grayscale of individual pixel within the block under calculation, and the second weighting factor (W2) of each object is calculated by the equation
W2=E(be₁)+E(be₂)+E(be₃)+E(be₄)+E(be₅)+E(be₆)+E(be₇)+E(be₈)+E(be₉).

4. The method as recited in claim 1, wherein the rearrangement of the plurality of objects is two-dimensional with x and y-directional movement.

5. The method as recited in claim 1, wherein the size R(s) is determined by the resolution or the number of pixel of the object under calculation.

6. The method as recited in claim 1, wherein the focus R(f) is determined by the equation f(x, y)/(w, h), in which f(x, y) denotes the coordinate of the focus of the object under calculation, (w, h) is the coordinate defined by the width (w) and height (h) of the object under calculation, and the origin of the coordinates is the upper left corner of the object under calculation.

7. The method as recited in claim 1, wherein face or eye position R(e) is determined by the equation e(x, y)/(w, h), in which e(x, y) is the coordinate of the face or eyes presented in the object under calculation, (w, h) is the coordinate defined by the width and height of the object under calculation, and the origin of the coordinates is the upper left corner of the object under calculation.

8. The method as recited in claim 1, wherein the position coordinate R(p) is determined by the equation p(x, y)/(w, h), in which p(x, y) is the coordinate of the upper left corner of the object under calculation, (w, h) is the coordinate defined by the width and height of the object under calculation, and the origin of the coordinates is the upper left corner of the display area.

9. The method as recited in claim 1, wherein the first weighting factor W1 is calculated by the following equation:
W1=R(s)+R(r)+R(f)+R(e)+R(p).

10. A computer-implemented method for presenting objects on a screen of a device, comprising the steps of:
presenting a plurality of objects within a display area of the screen;
calculating a weighting factor for each of the plurality of objects, wherein each of the plurality of objects is divided into nine blocks, and an entropy En is calculated for each block by the following equation:
E(beₙ)=−sum(g·log₂(g)),
wherein n=1−9 and g denotes the grayscale of individual pixel within the block under calculation, and the weighting factor (W2) of each object is calculated by the equation
W2=E(be₁)+E(be₂)+E(be₃)+E(be₄)+E(be₅)+E(be₆)+E(be₇)+E(be₈)+E(be₉);
and
rearranging the plurality of objects by comparing the weighting factor of the plurality of objects.

11. The method as recited in claim 10, wherein the rearrangement of the plurality of objects is two-dimensional with x and y-directional movement.

12. A computer-implemented method for presenting objects on a screen of a device, which comprises the steps of:
presenting a plurality of objects within a display area of the screen;
calculating a first weighting factor for each of the plurality of objects, wherein the first weighting factor comprises a size R(s), a width-to-height ratio R(r), a focus R(f), a face or eye position R(e), and a position coordinate R(p) parameter;
calculating a second weighting factor for each of the plurality of objects, wherein each of the plurality of objects is divided into nine blocks, and an entropy En is calculated for each block by the following equation:
E(beₙ)=−sum(g·log₂(g)),
wherein n=1−9 and g denotes the grayscale of individual pixel within the block under calculation, and the second weighting factor (W2) of each object is calculated by the equation
W2=E(be₁)+E(be₂)+E(be₃)+E(be₄)+E(be₅)+E(be₆)+E(be₇)+E(be₈)+E(be₉);
and
rearranging the plurality of objects by comparing the first weighting factor and/or the second weighting factor of the plurality of objects.
